(19) United States
(12) Patent Application Publication
(10) Pub. No.: US 2013/0041878 A1
(43) Pub. Date: Feb. 14, 2013

(54) AUTOSUGGESTING AN EQUIVALENT QUERY

(71) Applicants: ASHWIN SATYANARAYANA, Sammamish, WA (US); TABREEZ GOVANI, Bellevue, WA (US); SAMIR SHIRAZ PRADHAN, Bellevue, WA (US); BODO VON BILLERBECK, Melbourne (AU); NITIN AGRAWAL, Redmond, WA (US)

(72) Inventors: ASHWIN SATYANARAYANA, Sammamish, WA (US); TABREEZ GOVANI, Bellevue, WA (US); SAMIR SHIRAZ PRADHAN, Bellevue, WA (US); BODO VON BILLERBECK, Melbourne (AU); NITIN AGRAWAL, Redmond, WA (US)

(73) Assignee: MICROSOFT CORPORATION, REDMOND, WA (US)

(21) Appl. No.: 13/207,595

(22) Filed: Aug. 11, 2011

(51) Int. Cl. G06F 17/30

(52) U.S. Cl. 707/706; 707/767; 707/728; 707/E17.108; 707/E17.066; 707/E17.064

(57) ABSTRACT

Methods, systems, and computer-readable media for suggesting search queries to a user while the user is typing in characters of a search query. The suggested search queries are based in part on the characters entered and are presented before the user submits the query to the search engine. The suggested queries may be displayed in a dropdown box that allows the user to select one of the suggested queries. Embodiments of the present invention present search queries that do not begin with the characters entered by the user.

### BACKGROUND

Search engines allow users to locate relevant websites and other content. A search engine allows a user to submit a query and returns search results that are responsive to the query. Users may struggle to formulate queries that return search results that provide the information or services they are looking for. Some search engines suggest queries that a user can submit instead of writing their own query.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention suggest search queries to a user while the user is typing in characters of a search query. The suggested search queries are based, in part, on the characters entered. The suggested queries are presented before the user submits the query to the search engine. The characters entered by the user before submitting the query are called a search prefix within this disclosure. The search prefix may comprise at least one character and may comprise one or more words entered into a search query box.

As mentioned, embodiments of the present invention present search queries to the user. The suggested queries may be displayed in a dropdown box that allows the user to select one of the suggested queries. The suggested queries comprise either equivalent queries or auto-complete queries. An auto-complete query begins with the search prefix. Equivalent search queries do not begin with the search prefix entered by the user. The equivalent query may be generated using an auto-complete query as input. The equivalent query is displayed to the user for possible selection.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of an interface that includes equivalent query suggestions, in accordance with an embodiment of the present invention;

FIG. 3 is a diagram of a computing system architecture suitable for generating non-prefix-based equivalent query suggestions, in accordance with an embodiment of the present invention;

FIG. 4 is a diagram of a search interface that shows equivalent queries and auto-complete queries in response to a search prefix, in accordance with an embodiment of the present invention;

FIG. 5 is flow chart showing a method of generating equivalent queries, in accordance with an embodiment of the present invention;

FIG. 6 is flow chart showing a method of receiving a suggested equivalent query, in accordance with an embodiment of the present invention; and

FIG. 7 is a flow chart showing a method of generating equivalent queries for autosuggestion, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention suggest search queries to a user while the user is typing in characters of a search query. The suggested search queries are based, in part, on the characters entered. The suggested queries are presented before the user submits the query to the search engine. The characters entered by the user before submitting the query are called a search prefix within this disclosure. The search prefix may comprise at least one character and may comprise one or more words entered into a search query box.

As mentioned, embodiments of the present invention present search queries to the user. The suggested queries may be displayed in a dropdown box that allows the user to select one of the suggested queries. The suggested queries comprise either equivalent queries or auto-complete queries. An auto-complete query begins with the search prefix. Equivalent search queries do not begin with the search prefix entered by the user. The equivalent query may be generated using an auto-complete query as input. The equivalent query is displayed to the user for possible selection.

In one aspect, one or more computer-readable media having computer-executable instructions embodied thereon that when executed by a computing device perform a method of generating equivalent queries is described. The method comprises receiving a search prefix from a user. The search prefix is a group of characters entered by the user into a search interface. The search prefix is one or more characters in length and is one or more characters less than a complete search query. The method also comprises generating an auto-complete query that begins with the search prefix. The method also comprises generating an equivalent query that does not begin with the search prefix using the auto-complete query. The method further comprises displaying the equivalent query to the user before the user submits the complete search query.

In an additional aspect, a method of receiving a suggested equivalent query is described. The method comprises communicating a search prefix to a search interface. The method also comprises, before the search query is completed and submitted into the search interface, receiving an equivalent query that does not include the search prefix. The method also comprises displaying the equivalent query. The method also comprises receiving a selection of the equivalent query. The method also comprises receiving search results that are responsive to the equivalent query.

In another aspect, one or more computer-readable media having computer-executable instructions embodied thereon that when executed by a computing device perform a method of generating equivalent queries for autosuggestion is described. The method also comprises receiving a search prefix and generating an auto-complete query based on the search prefix. The method also comprises generating a plurality of equivalent queries using the auto-complete query as a basis. The plurality equivalent queries do not begin with the search prefix but share a subject matter with the auto-complete query. The method also comprises ranking individual equivalent queries within the plurality of equivalent queries.

Having briefly described an overview of embodiments of the invention, an exemplary operating environment suitable for use in implementing embodiments of the invention is described below.

### Exemplary Operating Environment

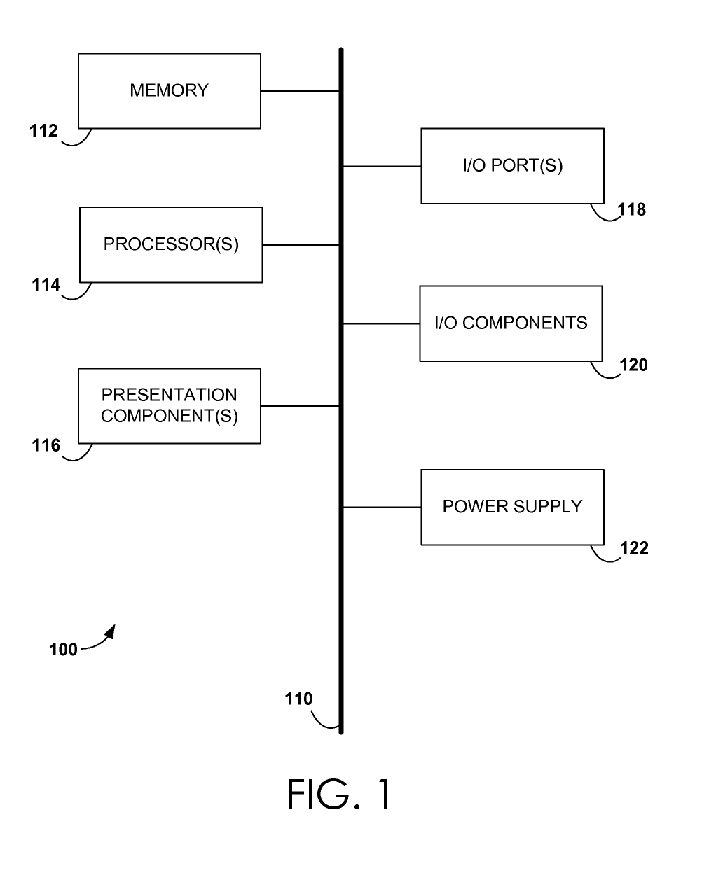

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks, or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-storage media. By way of example, and not limitation, computer-storage media may comprise Random Access Memory (RAM); Read Only Memory (ROM); Electronically Erasable Programmable Read Only Memory (EEPROM); flash memory or other memory technologies; Compact Disk Read-Only Memory (CDROM), digital versatile disks (DVDs) or other optical or holographic media; magnetic cassettes, magnetic tape, magnetic disk storage or other magnetic storage devices. The computer-storage media may be nontransitory.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

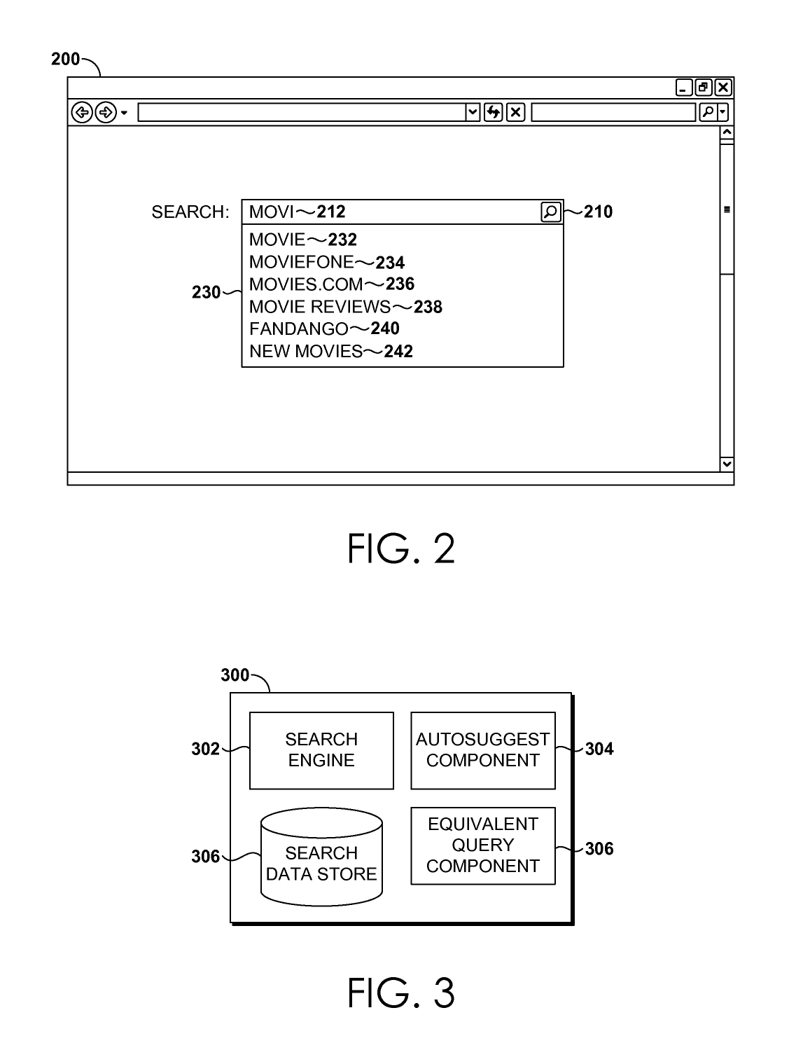

An embodiment of the present invention provide auto-suggest queries to a user as the user is typing a query. The partially typed query may be described as a search prefix. A search prefix comprises at least one or more characters, but may be less characters than a completed query. For example, the search prefix may be one or more characters or words less than a complete query. In another embodiment, the search prefix comprises any combination of characters and words entered into a search field before the search is submitted. In this embodiment, the search prefix may be a full query just before it is submitted. Embodiments of the present invention generate two different types of auto-suggestion queries: auto-complete queries and equivalent queries. Auto-complete queries start with letters and characters entered by the user (e.g., the search prefix) and add letters and words to build a full query. In contrast, the equivalent query does not begin with the search prefix and may not include the search prefix at all. Equivalent queries and auto-complete queries are illustrated in FIG. 2.

Turning now to FIG. 2, an interface showing equivalent and auto-complete query suggestions is shown, in accordance with an embodiment of the present invention. The search interface 200 may be associated with a search engine and accessed over the Internet. The search interface 200 includes a search box 210. As can be seen, the search box includes the search prefix 212 “movi.” The prefix 212 was provided by a user, but not yet submitted, for example, by pushing the enter key or another button on the interface that submits the query to the search engine. The prefix 212 is one or more characters less than a complete query. For example, the prefix may be an “e” short of “movie.” The prefix 212 could be an “e” and several other words short of the users intended full query. The prefix 212 is used to generate suggested queries. In an embodiment, the search prefix is analyzed without case sensitivity. For example, “MOVI” may be treated the same as “movi” or “mOvi.” A case folding process may be used to make the search prefix case insensitive. As the prefix changes with the addition of more characters the suggested queries may change.

The search interface 200 also includes a series of suggested queries 230. Each of the suggested queries 230 may be selected by a user and submitted to the search engine to return search results. The suggested queries 230 may be selected instead of completing a query.

The first suggested query is “movie” 232. Movie 232 is an auto-complete query since it begins with the search prefix “movi” 212. In one embodiment, the highest ranked suggested query is shown at the top of the suggested queries 230. The query rank may be determined using a combination of different factors. In one embodiment, the most frequently submitted query that starts with the search prefix, as determined by mining search session logs, is given the highest rank. In other embodiments, user characteristics including recent browsing history, demographic information, and other facts, may be used to rank a suggested query.

The next suggested query is for “moviefone” 234. The next suggested query is for “movies.com” 236. The next suggested query is “movie reviews” 238. As can be seen, suggested queries 232, 234, 236, and 238 all begin with the prefix “movi” 212. Each of these may be described as auto-complete query suggestion.

The two query suggestions at the end of the suggested queries 230 do not begin with the prefix “movi” 212. Instead, they represent equivalent queries or equivalent query suggestions. The next query suggestion shown is “fandango” 240 followed by “new movies” 242. Both of these query suggestions are related to movies. While related to movies, they do not begin with the search prefix 212 entered by the user. In this example, the equivalent queries are listed at the end of the suggested queries 230.

Embodiments in the present invention are not limited to displaying the equivalent queries at the end of the list. Several different display arrangements are possible. For example, equivalent queries may be interspersed with auto-complete queries, based on their overall ranking. When the equivalent queries are submitted at the end of a list of auto-suggestions, they may be put there based on different criteria. For example, the last two spaces could be reserved for the top two equivalent queries. In other cases, a backfill method may be used to insert equivalent queries when below a threshold number of auto-complete queries is generated.

### Exemplary System Architecture

Turning now to FIG. 3, an exemplary computing system architecture 300 suitable for generating equivalent query suggestions is shown, in accordance with an embodiment of the present invention. The computing system architecture 300 shown in FIG. 3 is an example of one suitable computing system architecture 300. The computing system architecture 300 comprises on one or more computing devices similar to the computing device 100 described with reference to FIG. 1. The computing system architecture 300 should not be interpreted as having any dependency or requirement related to any single module/component or combination of modules/components illustrated therein. The computing system architecture 300 includes a search engine 302, an auto-suggest component 304, a search data store 306, and an equivalent-query component 308.

The search engine 302 receives search queries and presents search results to the user. The search engine may include crawlers that explore available content and create an index that may be used to identify relevant content in response to search queries. The search queries, results shown in response to the search queries, and user interactions with these results may be stored within the search data store 306. The search data store 306 may also include the previously mentioned search indices, as well as other datasets generated by components shown or not shown in FIG. 3. In addition to the search engine 302, other components may read from and write data to the search data store 306.

The auto-suggest component 304 receives a search prefix. The search prefix includes characters submitted by a user in a search interface prior to selecting or submitting the search. The prefix may be less than a full word or as little as a single letter. In other embodiments, the prefix may include multiple words. In another embodiment, the prefix may include a few words as well as an incomplete word. The auto-suggest component 304 generates suggested queries and presents these to the user for possible selection.

In one embodiment, the auto-suggest component 304 generates auto-complete-suggested queries. The auto-complete-suggested queries begin with the search prefix submitted. As additional characters are entered by a user, the prefix may change and the auto-suggest component 304 may change the suggested queries in accordance with the additional characters received. The auto-suggest component 304 may also display one or more equivalent queries as suggestions to the users. As mentioned, the equivalent queries do not begin with the prefix. While they do not begin with the prefix, the equivalent could include the prefix. The auto-complete component may generate a group of auto-complete queries and a group of equivalent queries in advance. The auto-complete query may be looked up based on the search prefix and the equivalent query may then be looked up based on the auto-complete query.

The equivalent-query component 308 generates an equivalent query based on a prefix received by the search engine 302. The equivalent-query component 308 may generate the equivalent query using a number of different processes. These processes include a random walk process, session mining process, and a related suggestions stream. Each of these methods is described in more detail below.

The random walk process relies on a click log to identify related queries. The click log records the search results that are clicked on in response to a query. The click log may be taken from search data store 306. Two queries are determined to be related if they result in clicks on the same URL. For example, the queries “Barack Obama bio” and “President Obama bio” both result in clicks on the U.S. President's home page. Accordingly, both queries would be related to one another. The higher the ratio of co-clicks to all clicks from either query, the stronger the link between the query pair.

In one embodiment, the random walk process starts with generating a click graph that maps relationships between queries. The click graph may require a certain number of clicks on common URLs before creating a link, or relationship, between queries. In other embodiments, a single click on a common URL is enough to create the relationship. In another embodiment, instead of using clicks in general, the click graph is built using satisfied clicks. A satisfied click occurs when a user clicks on a URL and remains on the resulting content for greater than a threshold period of time, for example 30 seconds. The satisfied click indicates that the user is satisfied with the result. By inference, the result is responsive to the query. If satisfied clicks are used, the click graph may be called a satisfied click graph.

Embodiments of the present invention attempt to find an equivalent query that does not begin with the search prefix entered. Accordingly, when traversing a click graph to identify queries related to an input query, queries that begin with the search prefix may be excluded from a potential list of equivalent queries. In another embodiment, the filter is based on only the first letter of the search prefix. For example if the search prefix was MOVI as described previously in FIG. 2, then any related queries that start with the letter M could be excluded as potential equivalent queries. As mentioned, the generation of equivalent queries (and auto-complete queries) may be case insensitive.

Once a list of related queries that do not begin with the prefix (or some portion of the prefix) are generated, the strength of the relationship between the input query and the potential equivalent queries may be determined. In one embodiment, various potential equivalent queries are stack ranked based on the strength of the relationship. As mentioned, the more satisfied clicks in common, the stronger the relationship.

So the random walk process finds related queries given an input query. In embodiments of the invention, the input query may be an auto-complete query generated based on the search prefix. In one embodiment, the auto-complete queries are those that start with the search prefix and are most frequently submitted to the search engine according to the data in the search logs. Thus, given the auto-complete, query related queries may be identified. The related queries are then narrowed by excluding queries that begin with the prefix or have weak relationships with the input query.

The session mining process is a second method of generating an equivalent query Like the random walk process, the session mining process also starts with an auto-complete query generated from the search prefix. The auto-complete query used in the session mining process may be the highest-ranked auto-complete query. A session may be defined as the search activity occurring over a continuous period of time. For example, a single search session for a user may be the search activities that occur within ten minutes. The search activities may include submitting search queries and clicking on search results.

Embodiments of the present invention aggregate large amounts of session data to identify refined query pairs. A query pair comprises two search queries that enter consecutively submitted within a search session. Embodiments of the present invention may define a search session as a time period. For example, all queries entered within ten minutes may be part of the same search session. Thus, if a first query “airlines” is entered and the next query entered during that user's search session is “British Airlines” one minute later, then “airlines” and “British Airlines” would form a query pair. These qualify as a pair because they were consecutively entered within a search session.

Embodiments of the present invention further filter these query pairs to identify refined query pairs. In general, refined query pairs suggest that the second query is an improvement, or refinement, of the first query in the pair. The refined query pairs are identified when over a threshold number of satisfied clicks occur on the second query in the pair. The number of satisfied clicks that form the threshold can be established a number of different ways. For example, the threshold can be a percentage of times the second query in the pair produces satisfied clicks. For example, if a query pair occurs 100 times within the corpus of session log data, and the threshold was 10%, then in ten of the pairs, a satisfied click must occur in response to the second query in the pair.

In another embodiment, the satisfied click threshold is a number, such as 50. In this case, 50 satisfied clicks would need to occur in response to the second query in the pair regardless of how many times the query pairs occur within the corpus of session data. In yet another embodiment, the difference between satisfied clicks occurring in response to the first query in the pair and in response to the second query in the pair is considered. Again, the difference could be defined as a percentage or as an absolute number. The general concept is that the second query should receive more satisfied clicks if it is actually an improvement over the first query in the pair.

Other rules may be included to further define a refined pair. For example, pairs may only qualify as refined when they both include at least one word in common. In another example, a pair is only considered as refined when the user clicked on a search result presented in response to the second query, but not the first query. In other words, pairs initially identified where clicks, or satisfied clicks, occurred on both queries in the pair may be excluded as refined pairs.

The related suggestions process is a third method of generating an equivalent query that utilizes a search engine's related suggestion stream. The related suggestion stream provides suggested or related queries. In some cases, existing search engines use a related suggestions stream to identify related searches after a search query is submitted. The related suggestions are provided along with the search results. An embodiment of the present invention first completes a query from the search prefix to identify a likely full query. An equivalent query is determined by retrieving queries that are related to the completed query from the related suggestion data stream. Those related queries that begin with the search prefix may be excluded as equivalent queries.

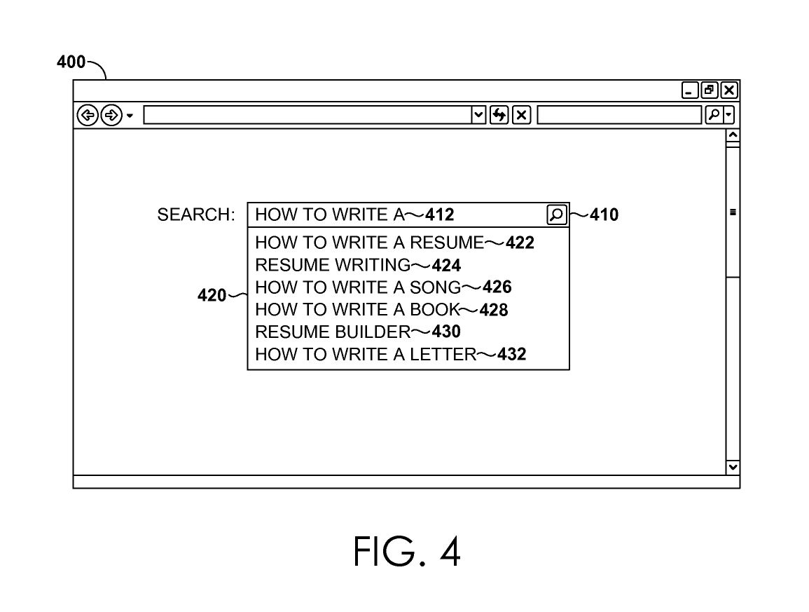

Turning now to FIG. 4, a search interface 400 that shows equivalent queries and auto-complete queries in response to a search prefix is shown, in accordance with an embodiment of the present invention. FIG. 4 illustrates a different way of displaying equivalent queries relative to auto-complete queries. In FIG. 4, the auto-complete queries and equivalent queries are interspersed.

The search interface 400 includes a search input box 410. As can be seen, the prefix, “how to write a” 412, is included in the input box 410. A group 415 of suggested queries is displayed to the user. The first suggested query 420 states “how to write a resume.” The second suggestion is “resume writing” 422. As can be seen, the second suggestion 422 is an equivalent suggestion that does not begin with the prefix 412. In this case, the equivalent suggestion 422 could be based on the first auto-complete query 420 which deals with the subject of resumes.

The suggested queries go on to include “how to write a song” 426, “how to write a book” 428, “resume builder” 430, and “how to write a letter” 432. As can be seen, resume builder 430 is also an equivalent query that is interspersed with the auto-suggest queries. This illustrates the interspersed method of displaying equivalent queries. In one embodiment, the auto-complete queries and the equivalent queries are ranked based on the satisfied clicks received in response to the query. A satisfied click is a click on a search result where the user stays on the search result for a period of time. This is different than a simple click, which does not have a time component. The satisfied click indicates that the user was satisfied with the search result and, by inference, that the search results are responsive to the query submitted. In one embodiment, the first query shown is always an auto-complete query and the remaining spaces allow auto-complete queries and equivalent queries to be interspersed according to rank.

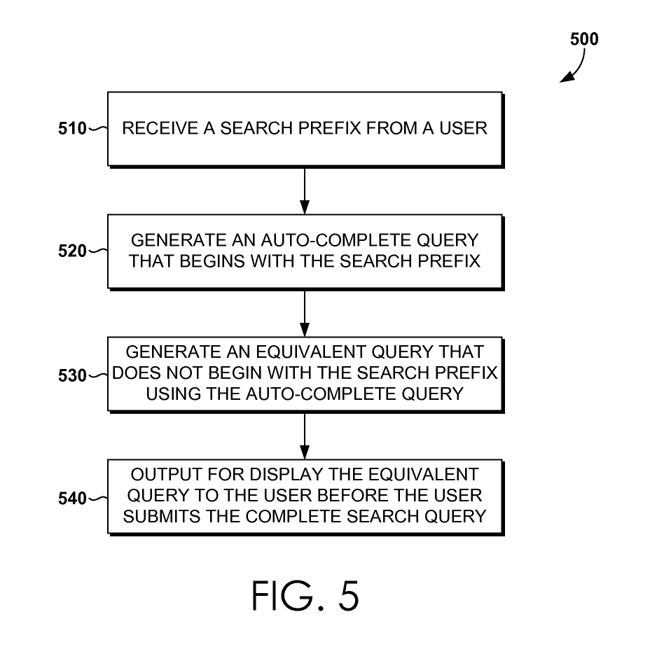

Turning now to FIG. 5, a method of generating equivalent queries is shown, in accordance with an embodiment of the present invention. As described previously, the method 500 may be performed in association with a search engine. The user described in the following steps may be a user that accesses a search engine through an interface provided over the Internet.

At step 510, a search prefix is received from a user. As mentioned, the search prefix may be inserted into an input or search box on a search website or a search utility. The search prefix is a group of characters entered by the user into the search interface. For example, the search prefix may be a few letters or a combination of words and letters. The search prefix is one or more characters less than a complete search query. Further, the search prefix is not submitted to the search engine and the user may continue to modify this search prefix by adding additional letters until a completed search query is created.

At step 520, an auto-complete query that begins with the search prefix is generated. The auto-complete query may be generated by analyzing session log data for previously submitted queries. In one embodiment, the auto-complete query is the most frequently occurring query in the query log that begins with the search prefix. The number of satisfied clicks received in response to a query may also be considered when determining the auto-complete query. In other embodiments, the auto-complete query may be selected based on user demographics or current search session data that allows an inference to be made about a user's intention. In this case, the auto-complete query may be selected based on an inferred intention rather than just the most commonly occurring query within the search session logs. In either case, the auto-complete query begins with the search prefix and is a complete query that could be submitted to the search engine.

At step 530, an equivalent query that does not begin with the search prefix is generated using the auto-complete query as input. In one embodiment, the equivalent query is not generated at runtime. A group of equivalent queries that correspond to one or more potential auto-complete queries may be generated before any search prefixes are received and stored for later use. Once the auto-complete query is generated, the equivalent queries may be obtained by performing a lookup against the group of auto-complete queries. The equivalent query is one that “matches” the auto-complete query. Various methods of determining an equivalent query have been described previously. These methods include the random walk process, the session mining process, and using a related query's data stream. These methods are applicable whether equivalent queries are calculated at runtime or in advance.

At step 540, the equivalent query is output for display to the user before the user submits the completed search query. There are several different ways for the equivalent query to be displayed to the user. In one embodiment, the equivalent query is displayed in a dropdown box beneath the search input box. The equivalent query could be displayed along with the auto-complete query and other suggested queries. The other suggested queries may be additional equivalent queries or additional auto-complete queries.

The equivalent query may be displayed a number of different ways. The equivalent queries could be displayed at the beginning or at the end of a series of suggested search queries. For example, the first two or the last two queries in a series of suggested queries may be designated for equivalent queries. In another embodiment, the equivalent queries are interspersed with auto-complete queries, as in FIG. 4. The equivalent queries and the auto suggest queries may be ranked. In one embodiment, the rank is based on the number or percentage of satisfied clicks that are returned in response to the particular query.

In another embodiment, additional equivalent queries are presented when less than a viable number or threshold number of auto-complete queries are generated. This method may be described as the backfill method as equivalent queries are added when not enough auto-complete queries exist. In one embodiment, the equivalent query does not include the search prefix at any point within the equivalent query.

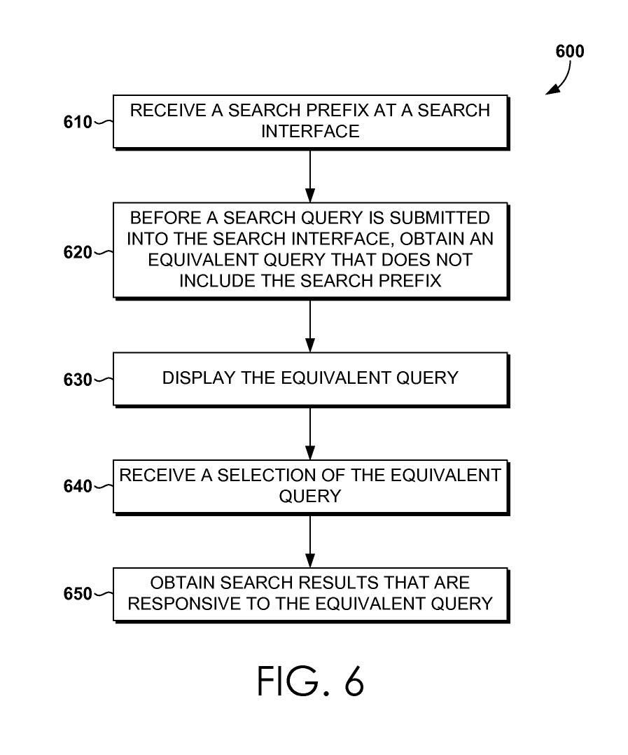

Turning now to FIG. 6, a method 600 of receiving a suggested equivalent query is described, in accordance with an embodiment of the present invention. Method 600 may be performed on an Internet browser or other application that accesses a search site or search tool. At step 610, a search prefix is received at a search interface. As described previously, the search interface may be part of an online search engine, a search tool such as a search toolbar, or other search function. The search prefix may be a series of characters that are typed into the search interface by a user. The search prefix may be several characters short of a complete query. In other words, the search prefix is generated during the process of a user submitting or typing a search query, but prior to them completing the typing or submission process. For example, the search prefix may be an incomplete word.

At step 620, before a search query is submitted into the search interface, an equivalent query that does not include the search prefix is obtained. The equivalent query may be based on the search prefix and determined using methods described previously, such as the random walk and session mining procedures. In this case, the equivalent query does not include the search prefix anywhere within the equivalent query. For example, in FIG. 2, the search prefix was “movi.” One of the equivalent queries was “fandango,” which does not include the prefix “movi.” On the other hand, the equivalent query “new movies” would not qualify as an equivalent query within method 600 because it includes the search prefix “movi,” though not at the beginning.

At step 630, the equivalent query is displayed to the user. Various methods of displaying the equivalent query to the user have been described previously. These methods include interspersing the equivalent query with auto-complete queries, displaying the equivalent query at the front or back of a group of other suggested queries, and intermingling the equivalent queries among other queries.

At step 640, a selection of the equivalent query is obtained. The selection may occur by a user taking a pointing device and clicking on the equivalent query. In another embodiment, the selection occurs when a user touches a touch screen with a finger or stylus above where the equivalent query is displayed. Upon receiving the selection, the equivalent query may be communicated to a search engine associated with the search interface.

At step 650, search results that are responsive to the equivalent query are received. The responsive search results may then be displayed to the user. In one embodiment, as additional characters are received in the search box, and the search prefix is subsequently changed, new equivalent queries are received and displayed to the user.

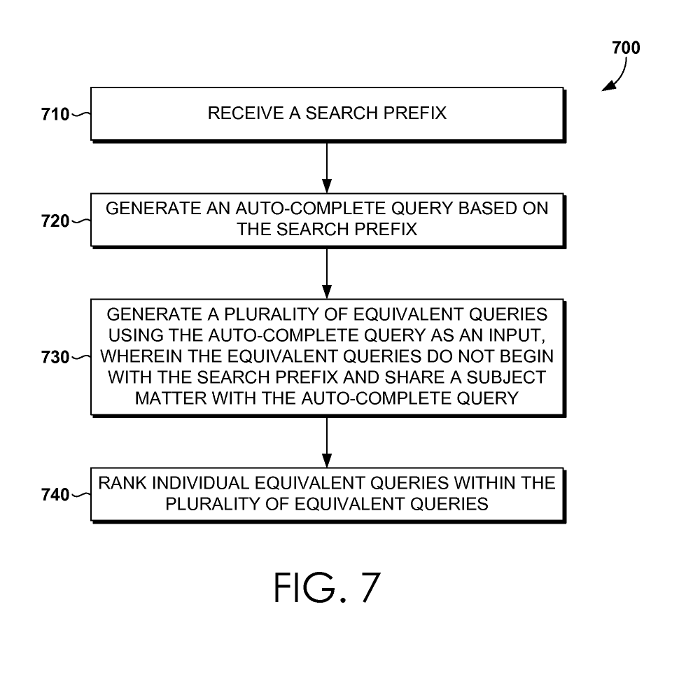

Turning now to FIG. 7, a method of generating equivalent queries for auto-suggestion is provided, in accordance with an embodiment of the present invention. At step 710, a search prefix is received. Search prefixes have been described previously. At step 720, an auto-complete query is generated based on the search prefix. Methods of generating auto-complete queries based on a search prefix have also been described previously and apply to method step 720.

At step 730, a plurality of equivalent queries are generated using the auto-complete query as an input. The equivalent queries do not begin with the search prefix and share a subject matter with the auto-complete query. The plurality of equivalent queries may be generated using the random walk methodology described previously, the related suggestions data stream, or their refinement query pairs generated through a search session analysis.

At step 740, individual equivalent queries within the plurality of equivalent queries are ranked. The ranking may be based on the number of clicks or satisfied clicks received on search results presented in response to the query. These clicks may be determined based on an analysis of search log data. Other methods of ranking individual equivalent queries may also be used. In one embodiment, individual equivalent queries above a certain rank are made available to display to the user as a suggested query. In one embodiment, the rank must be higher than the lowest available auto-complete query available or generated. In another embodiment, the rank of individual equivalent queries is compared to a rank calculated using a similar methodology for an auto-complete query and those query suggestions with the highest rank are displayed to the user.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-readable media having computer-executable instructions embodied thereon that when executed by a computing device perform a method of generating equivalent queries, the method comprising:
receiving a search prefix from a user, wherein the search prefix is a group of characters entered by the user into a search interface, and wherein the search prefix is one or more characters less than a complete search query;
generating an auto-complete query that begins with the search prefix;
generating an equivalent query that does not begin with the search prefix using the auto-complete query; and
outputting for display the equivalent query to the user before the user submits the complete search query.

2. The media of claim 1, wherein the auto-complete query starts with the search prefix.

3. The media of claim 1, wherein the equivalent query is selectable by the user and is input into a search engine upon selection.

4. The media of claim 1, wherein said generating the equivalent query is done using a random walk process.

5. The media of claim 1, wherein said generating the equivalent query is done by analyzing search session data to identify query pairs where a second query in a pair is a refinement over a first query in the pair, wherein the first query in the pair is the auto-complete query.

6. The media of claim 1, wherein the equivalent query is taken from a related suggestion stream available to a search engine.

7. The media of claim 1, wherein the equivalent query is displayed intermingled with auto-complete queries and other equivalent queries forming a group of auto- suggested queries.

8. The media of claim 7, wherein queries within the group of auto-suggested queries are ordered based on a number of satisfied clicks received on search results previously presented in response to each query.

9. A method of receiving a suggested equivalent query, the method comprising:
receiving a search prefix at a search interface;
before a search query is submitted into the search interface, obtaining an equivalent query that does not include the search prefix;
displaying the equivalent query;
receiving a selection of the equivalent query; and
obtaining search results that are responsive to the equivalent query.

10. The method of claim 9, wherein the equivalent query is displayed intermingled with one or more auto-complete query suggestions that begin with the search prefix.

11. The method of claim 9, wherein the equivalent query is displayed at the bottom of a list of one or more auto-complete query suggestions that begin with the search prefix.

12. The method of claim 9, wherein the method further comprises communicating additional characters that are added to the search prefix to create an updated search prefix, and receiving an updated equivalent query that does not begin with the updated search prefix.

13. One or more computer-readable media having computer-executable instructions embodied thereon that when executed by a computing device perform a method of generating equivalent queries for autosuggestion, the method comprising:
receiving a search prefix;
generating an auto-complete query based on the search prefix;
generating a plurality of equivalent queries using the auto-complete query as an input, wherein the a plurality equivalent queries do not begin with the search prefix and share a subject matter with the auto-complete query; and
ranking individual equivalent queries within the plurality of equivalent queries.

14. The media of claim 13, wherein the individual equivalent queries are ranked based on a number of satisfied clicks that are received on search results returned in response to an individual equivalent query.

15. The media of claim 13, wherein at least one of the plurality equivalent queries does not include the search prefix.

16. The media of claim 13, wherein at least one of the plurality equivalent queries is a second query within a refinement pair and the auto-complete query is a first query in the refinement pair.

17. The media of claim 13, wherein the method further comprises communicating a top-ranked equivalent query to a user before the user submits a search request that includes the search prefix.

18. The media of claim 17, wherein the method further comprises receiving a selection of the top-ranked equivalent query from the user and returning search results that are responsive to the top-ranked equivalent query.

19. The media of claim 17, wherein the top-ranked equivalent query is displayed after a series of auto-complete queries.

20. The media of claim 19, wherein the top-ranked equivalent query is displayed as a back-fill because less than a threshold number of auto-complete queries were available.
